(19) United States
(12) Patent Application Publication
(10) Pub. No.: US 2019/0276062 A1
(43) Pub. Date: Sep. 12, 2019

(54) WORK SURFACE FOR ATHLETIC TRAINER CART

(71) Applicant: Jeffrey K. Jackson, Murray, UT (US)

(72) Inventor: Jeffrey K. Jackson, Murray, UT (US)

(21) Appl. No.: 16/296,903

(22) Filed: Mar. 8, 2019

Related U.S. Application Data
(60) Provisional application No. 62/641,235, filed on Mar. 9, 2018.

(51) Int. Cl. B62B 3/02; B62B 3/00

(52) U.S. Cl. CPC B62B 3/02; B62B 3/005; A61G 12/001; B62B 3/008; B62B 3/004

(57) ABSTRACT

An athletic trainer cart is disclosed. The cart may include a frame, wheels connected to a bottom of the frame, padding connected to a top of the frame, and a drawer assembly. The padding may enable a top surface of the cart to be used as an examination table. The drawer assembly may selectively translate in and out of an interior volume of the frame. The drawer assembly may include a drawer and a drawer cover. The drawer cover may have a flat surface that may be used as a work surface when the drawer assembly is deployed and the drawer cover is in a closed position. A user may pivot the drawer cover with respect to the drawer to access one or more contents of the drawer.

### RELATED APPLICATIONS

This application claims the benefit of U.S. Provisional Patent Application Ser. No. 62/641,235 filed Mar. 9, 2018, which is hereby incorporated by reference.

### BACKGROUND

### Field of the Invention

This invention relates to equipment for athletic trainers and, more particularly, to novel systems and methods for a stowable work surface on an athletic trainer cart.

### Background Art

Athletic trainer carts are used by athletic trainers to assist in or facilitate their work. For example, an athletic trainer may use an athletic trainer cart to store his or her tools, supplies, etc. An athletic trainer may also use an athletic trainer cart to transport those tools, supplies, etc. to a location proximate a sporting event or contest (e.g., a sideline area next to a sports field or court).

In view of currently available offerings, what is needed are athletic trainer carts better adapted to meet the needs of athletic trainers.

### BRIEF DESCRIPTION OF THE DRAWINGS

The features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a system in accordance with the present invention in a fully stowed configuration;

FIG. 2 is a perspective view of an athletic trainer cart in a deployed configuration before installation of a work surface module in accordance with the present invention;

FIG. 3 is a perspective view of a system in a door-open configuration with a work surface module in a stowed configuration in accordance with the present invention;

FIG. 4 is an exploded view of one embodiment of a work surface module in accordance with the present invention;

FIG. 5 is a top perspective view of a system in a door-open configuration with a work surface module in accordance with the present invention in a first partially deployed position;

FIG. 6 is a top perspective view of a system in a door-open configuration with a work surface module in accordance with the present invention in a second partially deployed position; and

FIG. 7 is a top perspective view of a system in a door-open configuration with a work surface module in accordance with the present invention in a fully deployed position and the work surface in an open position.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

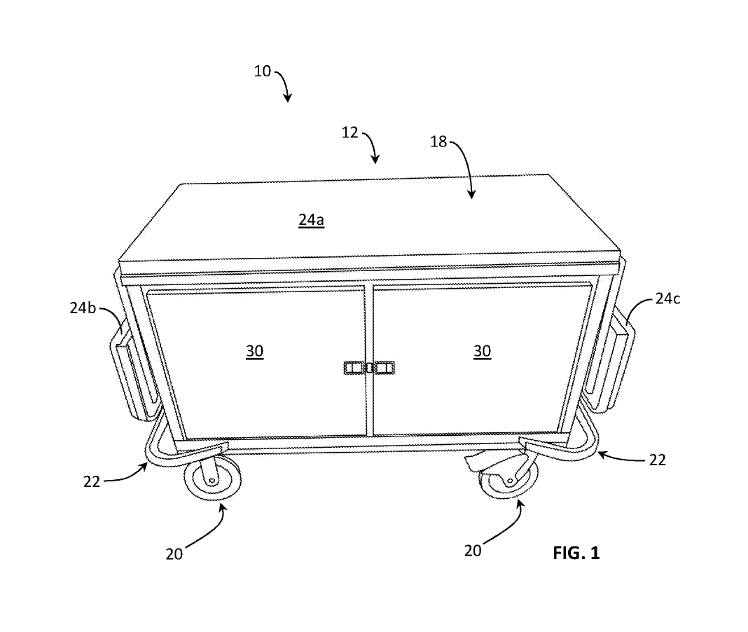

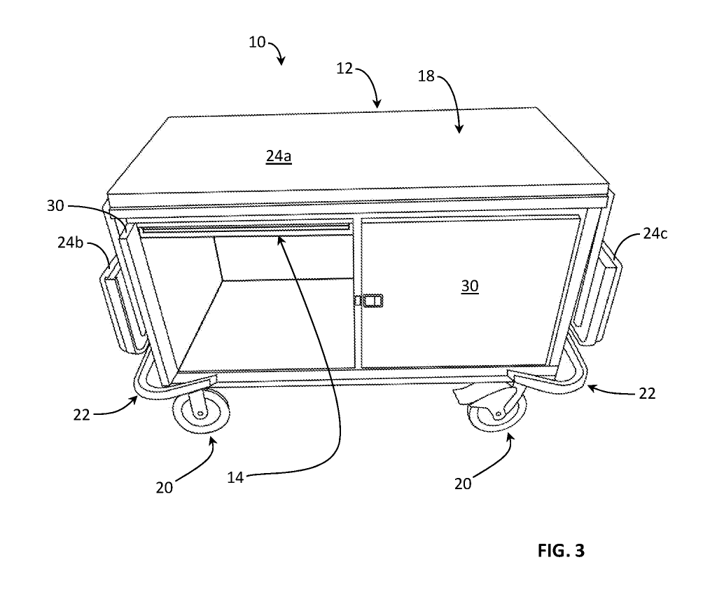

Referring to FIGS. 1-3, in selected embodiments a system 10 in accordance with the present invention may comprise an athletic trainer cart 12 and a work surface module 14. An athletic trainer cart 12 may comprise an enclosure 16, a top 18, a plurality of wheels 20, one or more bumpers 22, and the like or a combination or sub-combination thereof.

A top 18 may be connected to a top portion of an enclosure 16. In certain embodiments, a top 18 may be, comprise, or form an examination table. For example, a top 18 may include padding that makes it convenient and comfortable for an athlete to sit, lay, etc. on the top 18 as he or she receives preventative, diagnostic, or therapeutic health care (e.g., as he or she is being examined, taped, etc. by an athletic trainer). In selected embodiments, a top 18 may comprise multiple segments. For example, a top 18 may comprise a main portion 24a, a first extension 24b, and a second extension 24c.

A main portion 24a may correspond to, track, and/or follow the dimensions (e.g., footprint) of an enclosure 16. A main portion 24a may be fixed with respect to an enclosure 16. In contrast, first and second extension 24b, 24c may be configured to pivot or otherwise move with respect to an enclosure 16 and/or main portion 24a. For example, first and second extensions 24b, 24c may be configured to pivot or otherwise move between stowed configurations and deployed configurations.

When a system 10 or an athletic trainer cart 12 thereof is in a stowed configuration, the first and/or second extensions 24b, 24c may extend downward along a corresponding end wall of an enclosure 16. This may minimize the overall length of an athletic trainer cart 12 during transport, storage, etc. Conversely, when a system 10 or an athletic trainer cart 12 thereof is in a deployed configuration, the first and/or second extensions 24b, 24c may extend horizontally away from an enclosure 16 so as to combine or cooperate with the main portion 24a in forming a longer examination table (e.g., a table sufficiently long for an athlete to lie thereon and be fully supported).

A plurality of wheels 20 (e.g., four wheels 20) may be connected to a bottom portion of an enclosure 16. The wheels 20 may enable an athletic trainer cart 12 to be easily moved from one place to another. For example, the wheels 20 may enable an athletic trainer cart 12 to be easily pushed from a storage location to an athletic field or court and back again. Alternatively, or in addition thereto, the wheels 20 may enable an athletic trainer cart to be easily pushed from a truck or trailer to an athletic field or court and back again. Thus, an athletic trainer cart 12 may enable an athletic trainer to transport his or her gear, tools, supplies, etc. to where it needs to be without having to pack and unpack the cart 12.

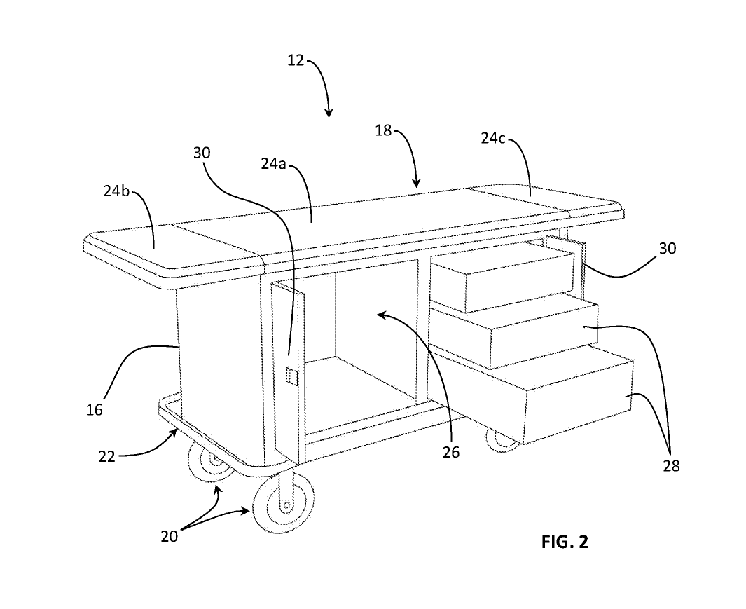

In selected embodiments, an enclosure 16 may define or comprise one or more interior compartments 26. Such compartments 26 may be left open, contain one or more shelves, contain one or more drawings 28, or the like. For example, in FIG. 2, the enclosure 16 defines or comprises two side-by-side internal compartments 26 of substantially equal volume. A first compartment 26 is configured an as open bay for receiving and/or storing larger or bulkier gear. A second compartment 26 houses a plurality of drawers 28.

In certain embodiments, an enclosure 16 may include one or more doors 30. Doors 30 may enable an enclosure 16 to transition between an open configuration and a closed configuration. In an open configuration, gear, tools, supplies, etc. stored within an enclosure 16 may be easily accessible. In a closed configuration (e.g., a closed and locked configuration), gear, tools, supplies, etc. stored within an enclosure 16 may be protected, inaccessible, or the like.

In selected embodiments, one door 30 may correspond to each interior compartment 26. For example, in FIG. 2, a first door 30 may correspond to and selectively close a first compartment 26 (e.g., an open bay compartment), while a second door 30 may correspond to and selectively close a second compartment 26 (e.g., a compartment equipped with a plurality of drawers 28).

In certain embodiments, one or more doors 30 may be pocket doors 30. Accordingly, once opened, the one or more doors 30 may be slid or backed into one or more corresponding pockets so that the doors 30 are out of the way when they are not needed.

In selected embodiments, a work surface module 14 may be mounted within an enclosure 16. For example, a work surface module 14 may be mounted within an interior compartment 26 of an enclosure 16. In certain embodiments, a work surface module 14 may extend the width and depth of an interior compartment 26 within which it is located. A work surface module 14 may be positioned at or near the top of an interior compartment 26. Accordingly, when a work surface of the module 14 is deployed, it may be at or near the same height as a top 18 of the corresponding athletic trainer cart 12.

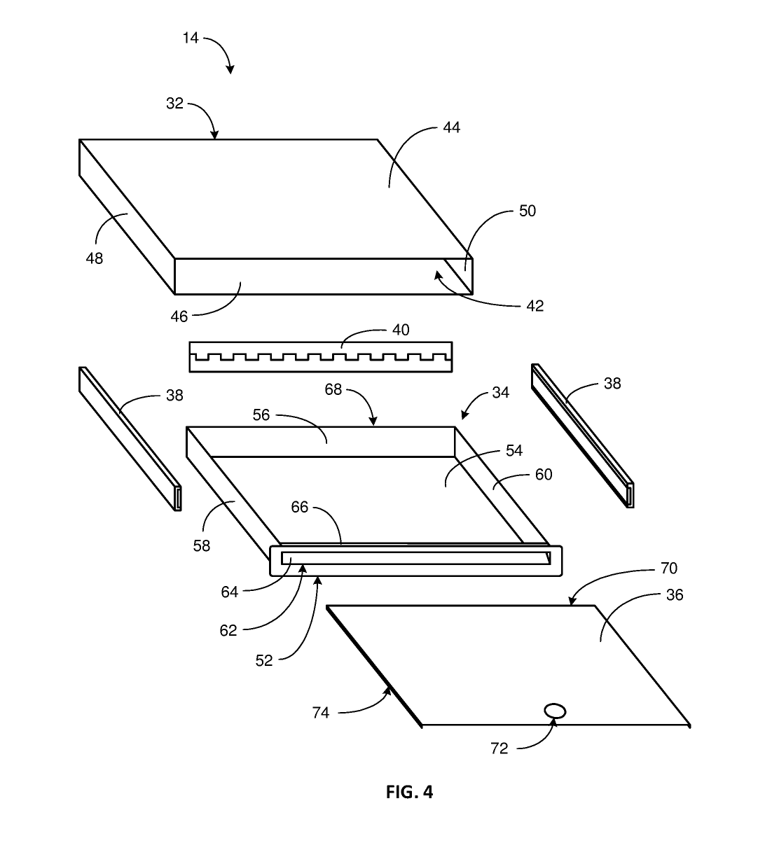

Referring to FIG. 4, in certain embodiments, a work surface module 14 in accordance with the present invention may comprise a housing 32, drawer 34, work surface 36, one or more slide mechanisms 38, one or more hinge mechanisms 40, or the like or a combination or sub-combination thereof. A work surface module 14 may be installed and removed from an athletic trainer cart 12 as desired or necessary. For example, a work surface module 14 may be installed within an athletic trainer cart 12 that was sold to a customer without any such module 14.

A housing 32 may define an outer perimeter of a work surface module 14 when that module 14 is in a stowed configuration. A housing 32 may support, provide, or enable a connection or securement that connects or fastens a work surface module 14 within an interior compartment 26. For example, a housing 32 may include one or more tabs, apertures, extensions, or the like that enable a corresponding work surface module 14 to be mounted within an interior compartment 26 with (or without) one or more screws, bolts, or other fasteners.

In selected embodiments, a housing 32 may protect the space 42 that is evacuated as a drawer 34 is deployed (e.g., pulled out of a housing 32). Accordingly, nothing (e.g., gear, tools, supplies, etc.) stored within an interior compartment 26 may enter that space 42. Thus, the space 42 may always be unoccupied should a user decide to stow the drawer 34 (e.g., push the drawer 34 completely or partially back into the housing 32).

In selected embodiments, a housing 32 may comprise a top 44, bottom 46, first side 48, and second side 50. The top 44, bottom 46, first side 48, and second side 50 may be generally planar. Accordingly, the space 42 within a housing 32 may be generally rectangular. In certain embodiments, the top 44, bottom 46, first side 48, and second side 50 may be formed by bending a piece of sheet metal in four places and then securing (e.g., welding, fastening) the ends together.

In selected embodiments, a drawer 34 may comprise a drawer face 52, bottom 54, back 56, first side 58, and second side 60. The drawer face 52, bottom 54, back 56, first side 58, and second side 60 may be generally planar. Accordingly, the interior volume within a drawer 34 may be generally rectangular in shape. In certain embodiments, a drawer face 52, bottom 54, back 56, first side 58, and second side 60 may be formed by bending and securing (e.g., welding, fastening) one or more pieces of sheet metal.

In certain embodiments, the space within a drawer 34 may be relatively shallow. Thus, the storage space within a drawer 34 may be useful, but may not be so large as to significantly intrude upon the overall storage volume within a corresponding interior compartment 26.

In certain embodiments, a drawer face 52 may comprise an indentation 62 formed therein. An indentation 62 may provide a location for the fingers of a user (e.g., an athletic trainer) to engage and deploy a drawer 34 (e.g., pull it out of a housing 32). In selected embodiments, an indentation 62 may be formed by cutting a rectangular tab 64 (e.g., cutting three sides or edges to form a tab 64) and then bending the tab 64 inward (e.g., bending the tab 64 on the fourth side or edge thereof). If desired or necessary, a top portion 66 of a drawer face 52 may be bent (e.g., bent to occupy or form a horizontal plane). A top portion 66 may provide a stop, abutment, support, or the like for a working surface 36 when the working surface 36 is in a closed position. Such components 64, 66 may also increase the rigidity, bending strength, or the like of a corresponding drawer 34.

In certain alternative embodiments, rather than having an indentation 62, a drawer face 52 may comprise one or more handles that extend outward (toward a user). One or more such handles may provide a location for the fingers of a user to engage and deploy a drawer 34. In still other embodiments, a drawer face 52 may comprise one or more apertures extending therethrough. The fingers of a user may engage one or more such apertures to deploy a drawer 34.

One or more slide mechanisms 38 (e.g., one or more telescoping ball bearing slides) may interface between a drawer 34 and a housing 32. For example, in selected embodiments, a first slide mechanism 38 may interface or extend between an inner surface of a first side 48 of a housing 32 and an outer surface of a first side 58 of a drawer 34. Similarly, a second slide mechanism 38 may interface or extend between an inner surface of a second side 50 of a housing 32 and an outer surface of a second side 60 of a drawer 34. Accordingly, one or more slide mechanisms 38 may enable a drawer 34 to slide easily in and out of a housing 32 and may support the drawing 34 when it is deployed or partially deployed (i.e., extending outside of a housing 32 to one extent or another).

One or more hinge mechanisms 40 (e.g., a single piano hinge) may pivotably connect a work surface 36 to a drawer 34. For example, one or more hinge mechanisms 40 may connect or interface between a top portion 68 of a back 56 of a drawer 34 and a back portion or edge 70 of a work surface 36. Accordingly, a work surface 36 may pivot with respect to a corresponding drawer 34 between a closed position, wherein the work surface 36 blocks access to the contents of the drawer 34, and an open position, wherein the contents of the drawer 34 are readily accessible.

In selected embodiments, a work surface 36 may include an aperture 72 extending therethrough. An aperture 72 may form a low profile engagement mechanism that enables a user (e.g., an athletic trainer) to selectively engage the work surface 36 and pivot it to an open position with respect to the underlying drawer 34.

In certain embodiments, one or more edges of a work surface 36 may form flanges 74 that extend in a different plane than a main portion of the work surface 36. Such flanges 74 may stiffen and strengthen a work surface 36, enhance the ability of the work surface 36 to engage an underlying drawing 34, and/or resist lateral play in the work surface 36. For example, in the illustrated embodiment, two opposing side edges of the work surface 36 comprise flanges 74 configured to overhang the top edges of the respective sides 58, 60 of the underlying drawer 34. This may improve the strength and aesthetic appeal of the work surface 36 when the corresponding drawer 34 is deployed.

In certain embodiments, one or more of the front, back, first side, and second side edges of a work surface 36 may form flanges 74. In selected embodiments, a work surface 36 and one or more flanges 74 thereof may be formed by bending a single piece of sheet metal.

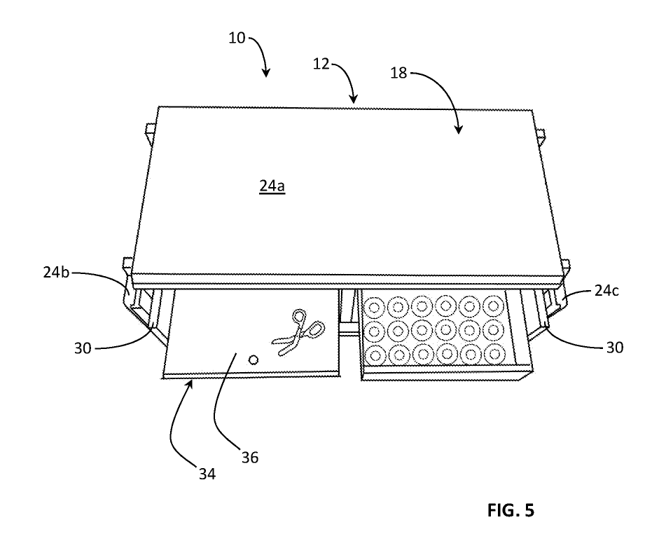

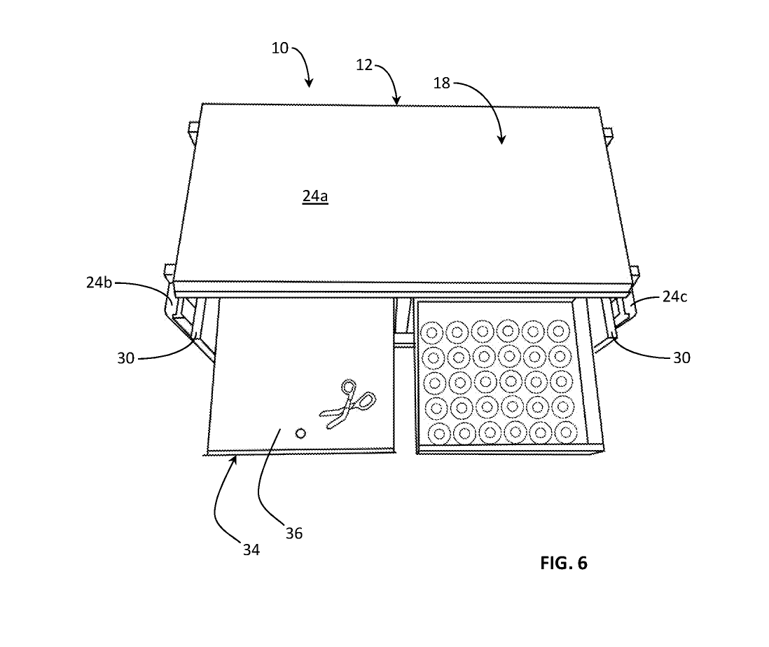

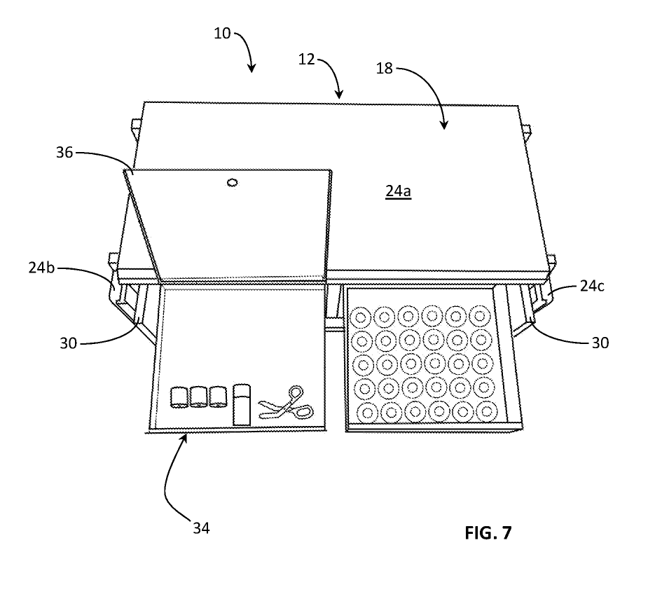

Referring to FIGS. 5-7, when a drawer 34 is stowed within a housing 32, a work surface 36 may be in a closed position and form or act like a closed lid for a corresponding drawer 34. As the drawer 34 is deployed (e.g., pulled from of the housing 32), the work surface 36 may remain in a closed position and continue to form or act like a closed lid for the drawer 34. Accordingly, once the drawer 34 is at least partially deployed, the work surface 36 may present to a user a flat top suitable for supporting gear, one or more tools, supplies or the like that a user (e.g., an athletic trainer) may place thereon. Alternatively, or in addition thereto, the work surface 36 may present to a user a surface for writing (e.g., on paper) and/or using a laptop computer, which may enable an athletic trainer to more easily track his or her treatment regimens. Additionally, an appropriate finish (e.g., a glossy powder coated surface) on a work surface 36 may render it suitable for being written on with a dry erase marker, which may enable an athletic trainer to more easily write simple notes, reminders, etc. thereon.

Advantageously, the flat top of the work surface 36 may be near a top 18 of a corresponding athletic trainer cart 12 without interfering with the use of that top 18. That is, it may be undesirable for a user to place his or her gear, tools, or supplies on a top 18 because that space may be needed and/or occupied by an athlete. The flat top of the work surface 36, on the other hand, may not be needed and/or occupied by an athlete. Accordingly, it may provide a convenient staging area for a user to place gear, tools, supplies, or the like that will need to be immediately on hand for a particular examination, treatment, taping, or the like.

Thus, without disturbing an athlete occupying a top 18, a user may deploy a drawer 34 and corresponding work surface 36, retrieve the necessary gear, tools, supplies, or the like from one or more storage locations within the storage compartments of the athletic trainer cart 12 (including any necessary gear, tools, supplies, or the like that may be stored within the drawer 34 itself), adjust the drawer 34 in or out of the housing 32 so that a desired amount of the work surface 36 is exposed (which amount may depend upon the body type and/or user preferences of the athletic trainer), and then stage the retrieved gear, tools, supplies, or the like on the exposed portion of the work surface 36 so that they are immediately on hand as the user attends to the athlete.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An athletic trainer cart comprising:
a frame having a top and a bottom and defining an interior volume;
a plurality of wheels connected to the frame proximate the bottom thereof;
padding connected to the frame proximate the top thereof;
a drawer assembly selectively translating with respect to the frame between a stowed position wherein the drawer assembly is within the interior volume of the frame and a deployed position wherein the drawer assembly is at least partially outside the interior volume of the frame; and
the drawer assembly comprising
a drawer having a drawer volume,
a cover having a flat surface,
the cover pivotably connected to the drawer, and
the cover selectively pivoting with respect to the drawer between a closed position wherein the cover cooperates with the drawer to enclose the drawer volume and an open position wherein the cover does not cooperate with the drawer to enclose the drawer volume.

2. The athletic trainer cart of claim 1, wherein:
the padding has a top surface;
the top surface of the padding is parallel to the top surface of the cover when the cover is in the closed position; and
the top surface of the padding is not parallel to the top surface of the cover when the cover is in the open position.

3. The athletic trainer cart of claim 2, wherein the drawer assembly is connected to the frame proximate the top thereof.

4. The athletic trainer cart of claim 3, wherein:
the top surface of the padding has a length and width;
the length of the top surface of the padding extends in a first direction;
the width of the top surface of the padding extends in a second direction orthogonal to the first direction; and
the draw assembly selectively translates with respect to the frame in the second direction.

5. The athletic trainer cart of claim 4, further comprising a housing containing the drawer assembly when the drawer assembly is in the stowed position.

6. The athletic trainer cart of claim 5, wherein the housing forms a rectangular sleeve having at least one open end.

7. The athletic trainer cart of claim 6, wherein the drawer assembly selectively translates in and out of the at least one open end as the drawer assembly moves into and out of the stowed position.

8. The athletic trainer cart of claim 7, wherein the housing cordons off from the rest of the interior volume a space vacated by the drawer assembly as the drawer assembly moves from the stowed position toward the deployed position.

9. The athletic trainer cart of claim 1, further comprising a housing containing the drawer assembly when the drawer assembly is in the stowed position.

10. The athletic trainer cart of claim 9, wherein:
the housing forms a rectangular sleeve having at least one open end;
the drawer assembly selectively translates in and out of the at least one open end as the drawer assembly moves into and out of the stowed position; and
the housing cordons off from the rest of the interior volume a space vacated by the drawer assembly as the drawer assembly moves from the stowed position toward the deployed position.

11. A method comprising:
obtaining an athletic trainer cart comprising
a frame having a top and a bottom and defining an interior volume,
a plurality of wheels connected to the frame proximate the bottom thereof,
padding connected to the frame proximate the top thereof, and
a drawer assembly selectively translating with respect to the frame between a stowed position wherein the drawer assembly is within the interior volume of the frame and a deployed position wherein the drawer assembly is at least partially outside the interior volume of the frame, and
the drawer assembly comprising
a drawer having a drawer volume,
a cover having a flat surface,
the cover pivotably connected to the drawer, and
the cover selectively pivoting with respect to the drawer between a closed position wherein the cover cooperates with the drawer to enclose the drawer volume and an open position wherein the cover does not cooperate with the drawer to enclose the drawer volume;
deploying the drawer assembly by pulling the drawer assembly out of the stowed position and into the deployed position;
accessing, while the drawer assembly is in the deployed position, one or more contents of the drawer by selectively pivoting the cover with respect to the drawer out of the closed position and into the open position; and
providing preventative, diagnostic, or therapeutic health care to a person seated or lying on the padding.

12. The method of claim 11, further comprising using, during the providing and while the drawer assembly is in the deployed position and the cover is in the closed position, the flat surface of the cover as a work surface.

13. The method of claim 11, wherein:
the padding has a top surface;
the top surface of the padding is parallel to the top surface of the cover when the cover is in the closed position; and
the top surface of the padding is not parallel to the top surface of the cover when the cover is in the open position.

14. The method of claim 13, wherein the drawer assembly is connected to the frame proximate the top thereof.

15. The method of claim 14, wherein:
the top surface of the padding has a length and width;
the length of the top surface of the padding extends in a first direction;
the width of the top surface of the padding extends in a second direction orthogonal to the first direction; and
the pulling comprises pulling the drawer assembly in the second direction.

16. The method of claim 11, wherein the athletic trainer cart further comprises a housing containing the drawer assembly when the drawer assembly is in the stowed position.

17. The method of claim 16, wherein:
the housing forms a rectangular sleeve having at least one open end; and
the pulling comprises pulling the drawer assembly out of the at least one open end.

18. The method of claim 17, further comprising cordoning off, by the housing, a space vacated by the drawer assembly as the drawer assembly translates from the stowed position toward the deployed position.
